(19) United States
(12) Patent Application Publication
(10) Pub. No.: US 2007/0286518 A1
(43) Pub. Date: Dec. 13, 2007

(54) Image processing apparatus and image processing method

(76) Inventors: Toshikazu Mitsutake, Kanagawa (JP); Noritaka Shimizu, Kanagawa (JP)

Correspondence Address: MCDERMOTT WILL & EMERY LLP, 600 13TH STREET, NW, WASHINGTON, DC, 20005-3096, US

(21) Appl. No.: 11/802,302

(22) Filed: May 22, 2007

(30) Foreign Application Priority Data
Jun. 8, 2006 (JP) JP 2006-159996

(51) Int. Cl. G06K 9/42

(52) U.S. Cl. 382/256

(57) ABSTRACT

An image processing apparatus includes a compressed image data memory, an image expansion unit, an expanded image data memory, a boundary image data memory, an image resizing unit, and a control unit. The control unit determines an area to be expanded by the image expansion unit based on a capacity of the expanded image data memory and a capacity of the boundary image data memory. The control unit determines a size of the area to be expanded by the image expansion unit, so that a size of image data obtained by expanding compressed image data corresponded to the area determined by the control unit is less than or equal to the capacity of the expanded image data memory, and less than or equal to the capacity of the boundary image data memory.

The present invention relates to an image processing apparatus and an image processing method which process compressed image data, in particularly, an image processing apparatus and an image processing method which change an expanded image to an optional size.

### BACKGROUND OF THE INVENTION

When reproducing digital image data compressed by a method such as a JPEG, after the compressed image data is expanded, an image size is changed to a size displayable in a display unit. FIG. 8 is a block diagram showing a heretofore known image processing apparatus. The image processing apparatus shown in FIG. 8 includes a compressed image data memory 11, an image expansion unit 13, an expanded image data memory 15, an image resizing unit 17 and a frame memory 19.

The compressed image data memory 11 stores the compressed image data. The image expansion unit 13 expands all compressed image data of one image. The expanded image data memory 15 stores the expanded image data. The image resizing unit 17 changes the image size to the size displayable in the not-shown display unit. The frame memory 19 stores data of the resized image.

In the heretofore described image processing apparatus, the image expansion unit 13 expands all the compressed image data of the one image. In the event that compressed image data of an image with a large image size is expanded, as image data of a large data size is obtained, an expanded image data memory 15 with a large capacity is necessary. However, from a point of view of a cost etc., the memory with the large capacity is not desirable. For this reason, an image processing apparatus disclosed in JP-A-2003-101934 expands the compressed image data for each area of an image configured of a plurality of areas, carries out an interpolation calculation of pixel data inside the expanded area, and changes the image size. According to the relevant apparatus, as the compressed image data is expanded by area, it is possible to downsize a capacity of a memory which stores the expanded image data.

However, with a method which carries out an interpolation calculation of pixel data inside an area, there is a restriction on a reduction and an enlargement ratio when changing an image size. For this reason, it is necessary to carry out a troublesome process when changing an image to an optional image size.

### SUMMARY OF THE INVENTION

An object of the invention is to provide an image processing apparatus and an image processing method in which a capacity of a memory storing expanded image data is small, and which enable a changing of an image to an optional size.

The invention provides an image processing apparatus, comprising:

a compressed image data memory which stores compressed image data;

an image expansion unit which expands the compressed image data read from the compressed image data memory for each area configuring one portion of an image;

an expanded image data memory which stores image data corresponded to an area expanded by the image expansion unit;

a boundary image data memory which stores boundary image data of an area adjacent to an area corresponded to the image data stored in the expanded image data memory;

an image resizing unit which changes a size of an image of an area corresponded to the image data read from the expanded image data memory; and

a control unit which determines an area to be expanded by the image expansion unit, based on a capacity of the expanded image data memory and a capacity of the boundary image data memory,

wherein the control unit determines a size of the area to be expanded by the image expansion unit, so that a size of image data obtained by expanding compressed image data corresponded to the area determined by the control unit is less than or equal to the capacity of the expanded image data memory, and less than or equal to the capacity of the boundary image data memory.

In the image processing apparatus, the image resizing unit changes the size of the image of the area corresponded to the image data read from the expanded image data memory, based on the image data read from the expanded image data memory and the boundary image data read from the boundary image data memory.

In the image processing apparatus, the image resizing unit calculates resized image data by an interpolation calculation, based on the image data read from the expanded image data memory and the boundary image data read from the boundary image data memory.

The invention also provides an image processing apparatus comprising:

a compressed image data memory which stores compressed image data;

an image expansion unit which expands the compressed image data read from the compressed image data memory for each area configuring one portion of an image, and having a width identical to a width of the image;

an expanded image data memory which stores the image data expanded by the image expansion unit;

an image resizing unit which changes a size of an image of an area corresponded to the image data read from the expanded image data memory; and

a control unit which determines an area to be expanded by the image expansion unit and an output address of the image expansion unit, based on a capacity of the expanded image data memory,

wherein the expanded image data memory stores boundary image data of a first area adjacent to a second area corresponded to the image data stored in the expanded image data memory; and

wherein the control unit determines a size of the area to be expanded by the image expansion unit, so that a size of image data obtained by expanding compressed image data corresponded to the area determined by the control unit is less than or equal to the capacity of the expanded image data memory.

In the image processing apparatus, when the image resizing unit changes a size of an image of the second area based on the boundary image data, the control unit sets the output address of the image expansion unit as an address immediately following the boundary image data.

In the image processing apparatus, when the image resizing unit changes the size of the image of the second area based on the boundary image data, the control unit sets an input address of the image resizing unit as an initial address of image data of the second area.

In the image processing apparatus, the expanded image data memory is a ring buffer.

The invention provides an image processing method comprising:

determining a size of an area configuring one portion of an image so that the size of the area is less than or equal to a capacity of an expanded image data memory which stores image data obtained by expanding compressed image data of a prescribed area, and is less than or equal to a capacity of a boundary image data memory which stores boundary image data of an area adjacent to an area corresponded to the image data stored in the expanded image data memory;

expanding compressed image data of the determined area;

changing a size of an image of an area corresponded to the expanded image data; and

storing boundary image data adjacent to another area of the expanded image data in the boundary image data memory.

The invention also provides an image processing method comprising:

determining a size of an area configuring one portion of an image, and having a width identical to a width of the image, so that the size of the area is less than or equal to a capacity of an expanded image data memory which stores image data obtained by expanding compressed image data of a prescribed area;

expanding compressed image data corresponded to the determined area;

changing a size of an image of the area corresponded to the expanded image data; and

determining a next area to be expanded, and an output address to the expanded image data memory of image data obtained by expanding compressed image data of the next area based on the capacity of the expanded image data memory.

According to the image processing apparatus and the image processing method according to the invention, it is possible to reduce a capacity of a memory which stores expanded image data, and change an image to an optional size.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a block diagram showing a configuration of an image processing apparatus of a first embodiment;

FIG. 2 is a flowchart showing an operation of the image processing apparatus of the first embodiment;

FIG. 3 is a diagram showing an image divided into a plurality of areas in a second embodiment;

FIG. 4 is a block diagram showing a configuration of an image processing apparatus of a second embodiment;

FIG. 5 is a diagram showing an expanded image data memory in which is stored image data of a first area from an initial address;

FIG. 6 is a diagram showing an expanded image data memory in which is stored a final address from an address immediately following boundary image data of the first area, and image data of a second area continuing from the initial address;

FIG. 7 is a flowchart showing an operation of the image processing apparatus of the second embodiment; and

FIG. 8 is a block diagram showing a heretofore known image processing apparatus.

### DETAILED DESCRIPTION OF THE PREFERRED EMBODIMENTS

Hereafter, a description will be given of embodiments of the invention with reference to the drawings.

### First Embodiment

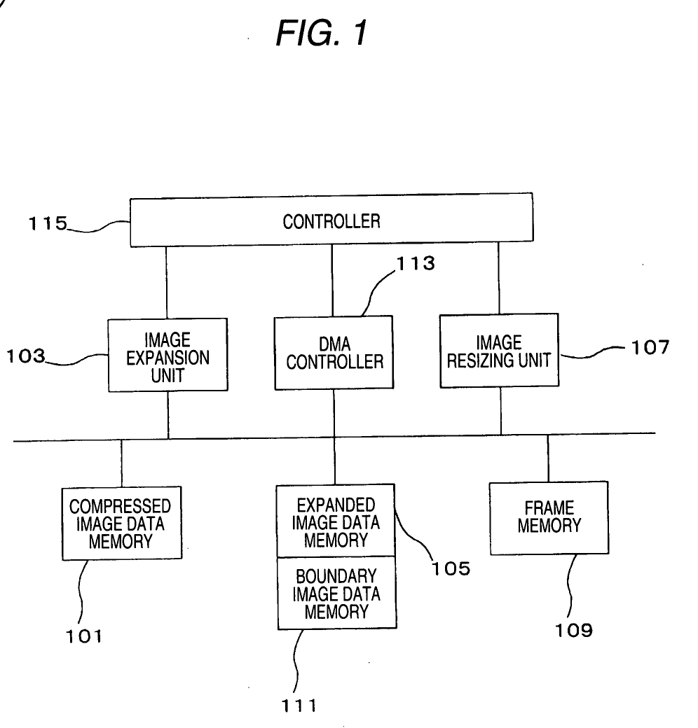

FIG. 1 is a block diagram showing a configuration of an image processing apparatus of a first embodiment. As shown in FIG. 1, the image processing apparatus of the first embodiment includes a compressed image data memory 101, an image expansion unit 103, an expanded image data memory 105, an image resizing unit 107, a frame memory 109, a boundary image data memory 111, a DMA controller 113 and a controller 115.

The compressed image data memory 101 stores compressed image data. The image expansion unit 103 expands the compressed image data by image area determined by the controller 115. The expanded image data memory 105 stores image data of one area expanded by the image expansion unit 103. The image resizing unit 107 reads the image data from the expanded image data memory 105 by area, and changes a size of an image of the area read. Also, the image resizing unit 107 carries out an interpolation calculation of a plurality of pixels adjacent to another area. When the image resizing unit 107 carries out the interpolation calculation, in the event that image data is stored in the boundary image data memory 111, to be described hereafter, the image resizing unit 107 also reads the image data from the boundary image data memory 111. In this case, the image resizing unit 107 carries out the interpolation calculation using the image data read from the expanded image data memory 105 and the image data read from the boundary image data memory 111. The frame memory 109 stores data of the image of the area which has been resized.

The boundary image data memory 111 stores image data (border image data) necessary for the image resizing unit 107 to carry out the interpolation calculation. The border image data is transferred from the expanded image data memory 105. The DMA controller 113 controls a transfer of the image data from the expanded image data memory 105 to the boundary image data memory 111. The controller 115 controls the image expansion unit 103, the image resizing unit 107 and the DMA controller 113. The controller 115 determines a size of an area which is a unit by which the image expansion unit 103 expands the compressed image data, with reference to a capacity of the expanded image data memory 105 and the boundary image data memory 111. At this time, the controller 115 determines the size of the area in such a way that a size of the image data of the expanded one area is less than or equal to the capacity of the expanded image data memory 105, and less than or equal to the capacity of the boundary image data memory 111. Also, the controller 115 sets an initial value of an interpolation coefficient in the image resizing unit 107.

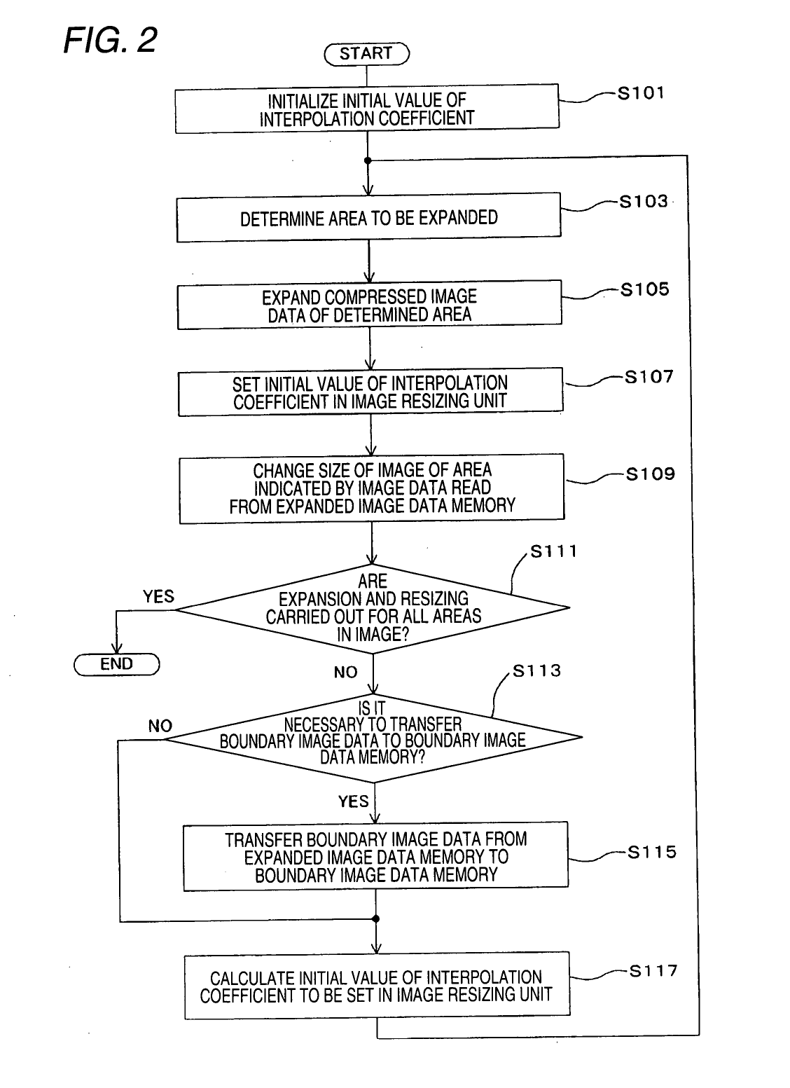

FIG. 2 is a flowchart showing an operation of the image processing apparatus of the first embodiment. First, in step S101, the controller 115 initializes the initial value of the interpolation coefficient to be set in the image resizing unit 107. Next, in step S103, the controller 115 determines an area to be expanded by the image expansion unit 103, and sets the area in the image expansion unit 103. Next, in step 105, the image expansion unit 103 reads compressed image data of the area determined in step S103 from the compressed image data memory 101, expands the compressed image data, and stores the expanded image data in the expanded image data memory 105. Next, in step S107, the controller 115 sets the initial value of the interpolation coefficient in the image resizing unit 107. Next, in step S109, the image resizing unit 107 reads the image data from the expanded image data memory 105, changes an image size of an area indicated by the relevant image data, and stores data of the resized image in the frame memory 109.

Next, in step S111, the controller 115 judges, for all areas in the image, whether an expansion or a resizing has been carried out and, if all areas have been processed (YES), finishes a process for the relevant image while, if there is an unprocessed area (NO), it proceeds to step S113. In step 113, for the purpose of the interpolation calculation of image data in adjacent areas, the controller 115 judges whether it is necessary to transfer boundary image data, in the image data stored in the expanded image data memory 105, to the boundary image data memory 111 and, if it is necessary (YES), proceeds to step S115 while, if it is not necessary, it proceeds to step S117. In step S115, the DMA controller 113, after transferring the boundary image data from the expanded image data memory 105 to the boundary image data memory 111, proceeds to step S117. In step S117, the controller 115, when changing a size of an image of an adjacent area, calculates the initial value of the interpolation coefficient set in the image resizing unit 107 in step S107. After step S117 is completed, the controller 115 returns to step S101 and continues the process.

In the event that the image has a plurality of color components, the heretofore described image resizing is carried out by color component. Also, it is acceptable that the transfer of the image data from the expanded image data memory 105 to the boundary image data memory 111 is carried out using a processor such as a CPU, instead of using the DMA controller 113.

As described heretofore, according to the image processing apparatus of the embodiment, it is possible to change the size of the image to a desired size without using a large capacity expanded image data memory. That is, it is possible to resize the image to an optional size in the small capacity expanded image data memory 105.

### Second Embodiment

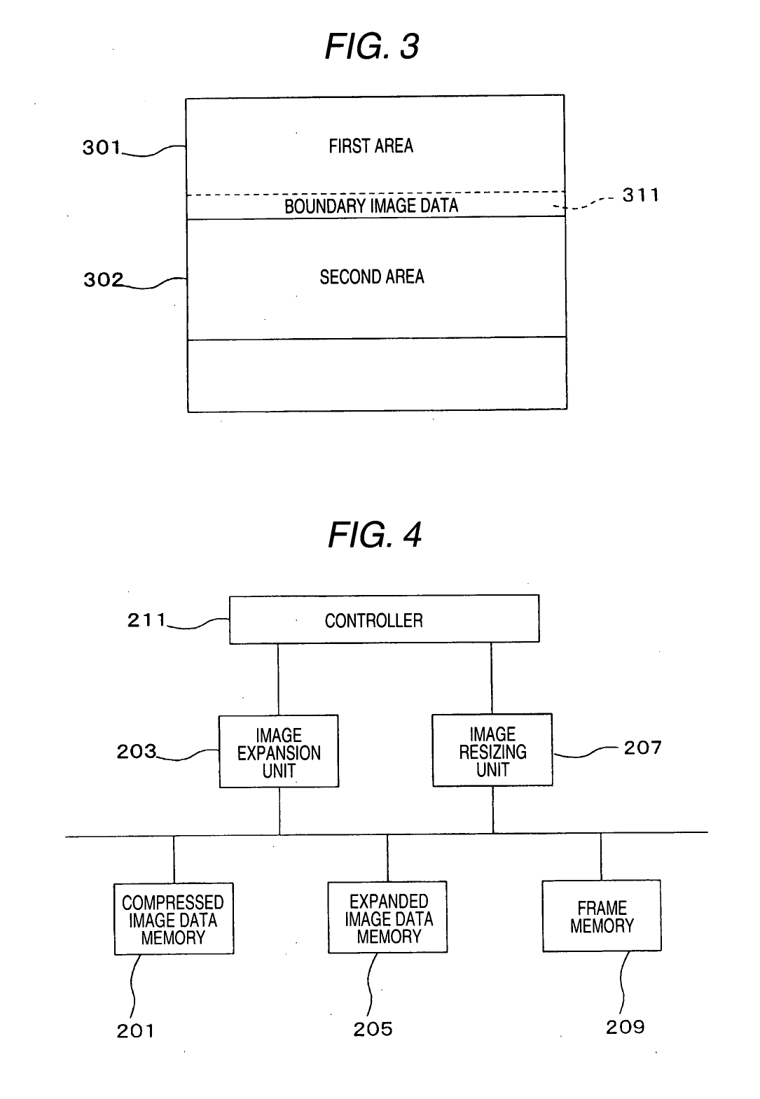

In a second embodiment, as shown in FIG. 3, a width of one area is set to be identical to a width of an image. That is, when the image is divided into a plurality of areas, the relevant image is not segmented in a vertical direction. Also, the expanded image data memory is configured of a ring buffer.

FIG. 4 is a block diagram showing a configuration of an image processing apparatus of the second embodiment. As shown in FIG. 4, the image processing apparatus of the second embodiment includes a compressed image data memory 201, an image expansion unit 203, an expanded image data memory 205, an image resizing unit 207, a frame memory 209 and a controller 211.

The compressed image data memory 201 stores the compressed image data. The image expansion unit 203 expands the compressed image data by image area determined by the controller 211. The expanded image data memory 205 stores image data of one area expanded by the image expansion unit 203. The expanded image data memory 205 of the embodiment is the ring buffer. For this reason, the image expansion unit 203, when reaching a final address during a writing of the expanded image data into the expanded image data memory 205, continues by overwriting from an initial address and storing.

The image resizing unit 207 reads the image data from the expanded image data memory 205 by area, and changes a size of an image of the area read. Also, in the same way as in the first embodiment, the image resizing unit 207 carries out an interpolation calculation of a plurality of pixels adjacent to another area. For example, as shown in FIG. 3, in a case in which a first area 301 and a second area 302 are adjacent to each other, the image resizing unit 207 carries out the interpolation calculation on a plurality of pixels (boundary image data) 311 which are at a lower edge of the first area 301, adjacent to the second area 302. The frame memory 209 stores data of the image of the area which has been resized.

The controller 211 controls the image expansion unit 203 and the image resizing unit 207. Also, the controller 211 sets an initial value of an interpolation coefficient in the image resizing unit 207. Furthermore, the controller 211 determines a size of an area which is a unit by which the image expansion unit 203 expands the compressed image data, and an output address of the image expansion unit 203, with reference to a capacity of the expanded image data memory 205. At this time, the controller 211 determines the size of the relevant area, and the output address of the image expansion unit 203, in such a way that a size of the image data of the expanded one area is less than or equal to the capacity of the expanded image data memory 205. The output address of the image expansion unit 203 refers to an initial address in the expanded image data memory 205, in which is stored the expanded image data expanded by the image expansion unit 203.

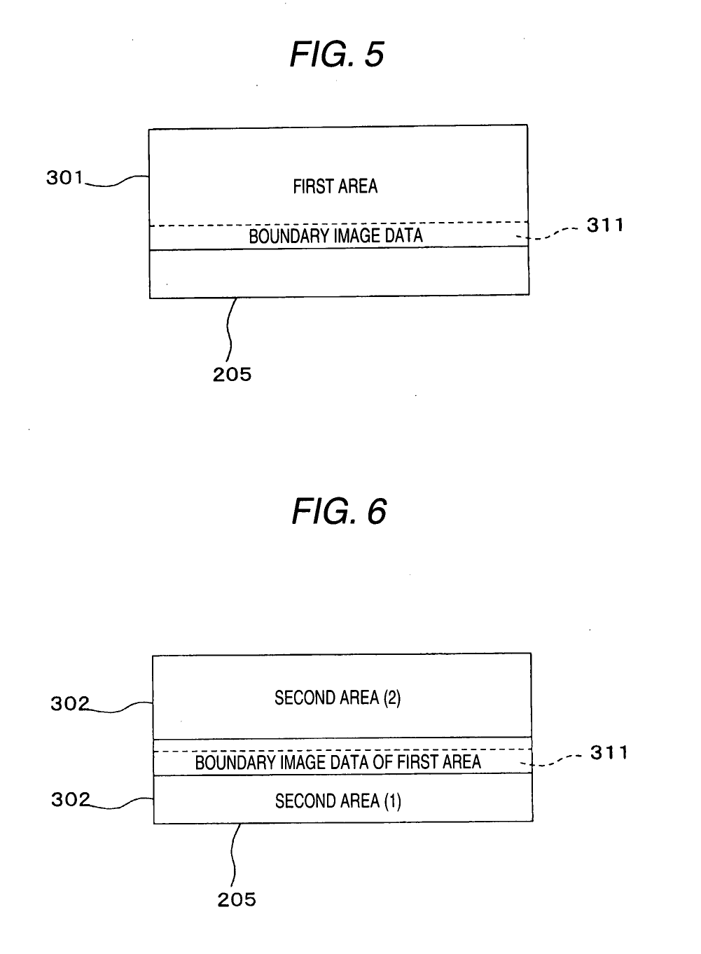

In the event that the image resizing unit 207 does not need the boundary image data 311 at the lower edge of the first area 301 when changing an image size of the second area 302 shown in FIG. 3, the controller 211, as shown in FIG. 5, sets the output address of the image expansion unit 203 as the initial address of the expanded image data memory 205. FIG. 5 shows the expanded image data memory 205 in which is stored image data of the first area 301 from the initial address.

Meanwhile, in the event that the image resizing unit 207 needs the boundary image data, the controller 211, as shown in FIG. 6, in order that the boundary image data 311 of the image of the first area 301 stored in the expanded image data memory 205 is not overwritten by image data of the second area 302, sets the output address of the image expansion unit 203 as an address immediately following the relevant boundary image data 311. FIG. 6 shows the expanded image data memory 205 in which are stored the final address from the address immediately following the boundary image data 311 of the image of the first area 301, and the image data of the second area 302 continuing from the initial address.

Furthermore, the controller 211 sets an input address of the image resizing unit 207. The input address of the image resizing unit 207 refers to an initial address in the expanded image data memory 205 from which image data is read by the image resizing unit 207. In the event that the image resizing unit 207 does not need the boundary image data 311 at the lower edge of the first area 301 when changing the image size of the second area 302, the controller 211 sets the input address of the image resizing unit 207 as the initial address of the image data of the second area 302. Meanwhile, in the event that the image resizing unit 207 needs the boundary image data, the controller 211 sets the input address of the image resizing unit 207 as the initial address of the image data of the second area 302.

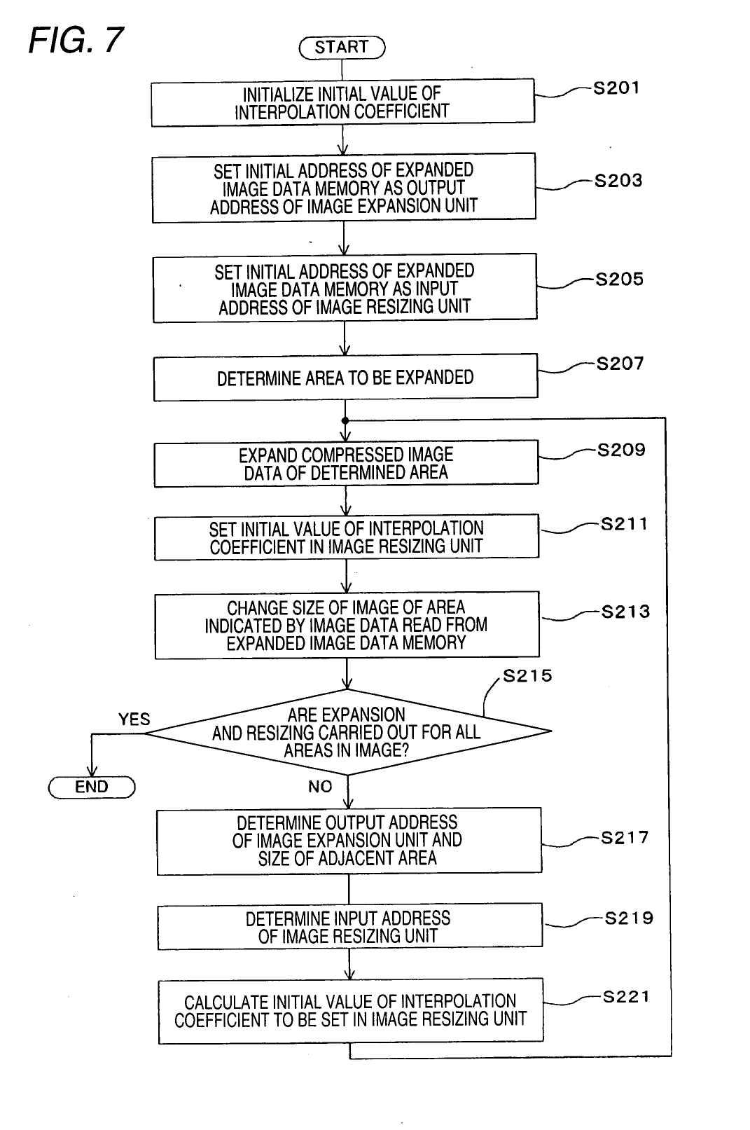

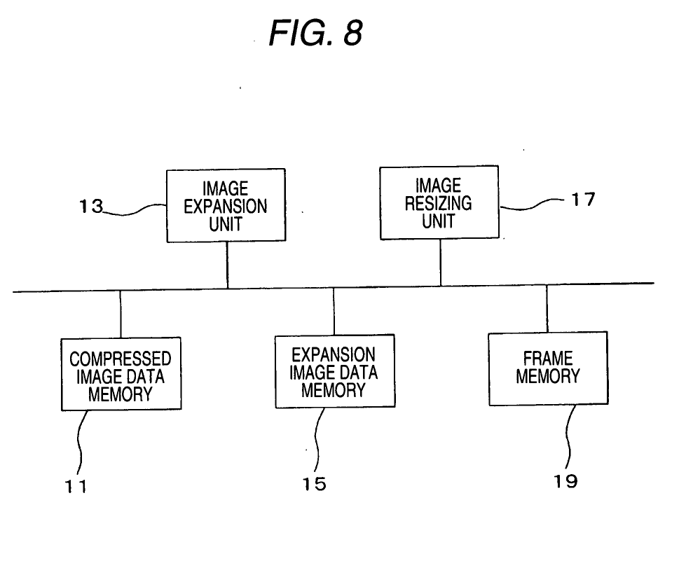

FIG. 7 is a flowchart showing an operation of the image processing apparatus of the second embodiment. First, in step S201, the controller 211 initializes the initial value of the interpolation coefficient to be set in the image resizing unit 207. Next, in step S203, the controller 211 sets the initial address of the expanded image data memory 205 as the output address of the image expansion unit 203. Next, in step 205, the controller 211 sets the initial address of the expanded image data memory 205 as the input address of the image resizing unit 207. Next, in step S207, the controller 211 determines a size of an area to be expanded by the image expansion unit 203, and sets it in the image expansion unit 203.

Next, in step S209, the image expansion unit 203 reads compressed image data of the area determined in step S207 or in step S217, to be described hereafter, from the compressed image data memory 201, expands the compressed image data, and stores the expanded image data in the expanded image data memory 205. FIG. 6 shows an example of the image data stored in the expanded image data memory 205 in step S209. Next, in step S211, the controller 211 sets the initial value of the interpolation coefficient in the image resizing unit 207. Next, in step S213, the image resizing unit 207 reads the image data from the expanded image data memory 205, changes a size of an image of an area indicated by the relevant image data, and stores data of the resized image in the frame memory 209.

Next, in step S215, the controller 211 judges, for all areas in the image, whether an expansion or a resizing has been carried out and, if all areas have been processed (YES), finishes a process for the relevant image while, if there is an unprocessed area (NO), it proceeds to step S217. In step 217, the controller 211 determines the output address of the image expansion unit 203 and the size of the adjacent area when the image expansion unit 203 expands compressed image data of an area adjacent to the area expanded in step S209, and sets them in the image expansion unit 203. Next, in step S219, the controller 211 determines the input address of the image resizing unit 207, and sets the input address in the image resizing unit 207. Next, in step S221, the controller 211 calculates the initial value of the interpolation coefficient to be set in the image resizing unit 207 in step S211 when changing the size of the image of the adjacent area. After step S221 is completed, the controller 211 returns to step S209 and continues the process.

In the same way as in the first embodiment, in the event that the image has a plurality of color components, the heretofore described image resizing is carried out by color component.

As heretofore described, according to the image processing apparatus of the embodiment, as it is not necessary to furnish the boundary image data memory 111 provided in the first embodiment, it is possible to further downsize an overall memory size. Also, as it is not necessary to furnish the DMA controller 211 provided in the first embodiment, it is possible to provide an image processing apparatus with a simple configuration.

The image processing apparatus and the image processing method according to the invention are useful as an image processing apparatus etc. in which the capacity of the memory storing the expanded image data is small, and which change the image to an optional size.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japan Patent Application No. 2006-159996 filed on Jun. 8, 2006, the contents of which are incorporated herein for reference.

What is claimed is:

1. An image processing apparatus, comprising:
a compressed image data memory which stores compressed image data;
an image expansion unit which expands the compressed image data read from the compressed image data memory for each area configuring one portion of an image;
an expanded image data memory which stores image data corresponded to an area expanded by the image expansion unit;
a boundary image data memory which stores boundary image data of an area adjacent to an area corresponded to the image data stored in the expanded image data memory;
an image resizing unit which changes a size of an image of an area corresponded to the image data read from the expanded image data memory; and
a control unit which determines an area to be expanded by the image expansion unit, based on a capacity of the expanded image data memory and a capacity of the boundary image data memory,
wherein the control unit determines a size of the area to be expanded by the image expansion unit, so that a size of image data obtained by expanding compressed image data corresponded to the area determined by the control unit is less than or equal to the capacity of the expanded image data memory, and less than or equal to the capacity of the boundary image data memory.

2. The image processing apparatus according to claim 1, wherein the image resizing unit changes the size of the image of the area corresponded to the image data read from the expanded image data memory, based on the image data read from the expanded image data memory and the boundary image data read from the boundary image data memory.

3. The image processing apparatus according to claim 2, wherein the image resizing unit calculates resized image data by an interpolation calculation, based on the image data read from the expanded image data memory and the boundary image data read from the boundary image data memory.

4. An image processing apparatus, comprising:
a compressed image data memory which stores compressed image data;
an image expansion unit which expands the compressed image data read from the compressed image data memory for each area configuring one portion of an image, and having a width identical to a width of the image;
an expanded image data memory which stores the image data expanded by the image expansion unit;
an image resizing unit which changes a size of an image of an area corresponded to the image data read from the expanded image data memory; and
a control unit which determines an area to be expanded by the image expansion unit and an output address of the image expansion unit, based on a capacity of the expanded image data memory,
wherein the expanded image data memory stores boundary image data of a first area adjacent to a second area corresponded to the image data stored in the expanded image data memory; and
wherein the control unit determines a size of the area to be expanded by the image expansion unit, so that a size of image data obtained by expanding compressed image data corresponded to the area determined by the control unit is less than or equal to the capacity of the expanded image data memory.

5. The image processing apparatus according to claim 4, wherein when the image resizing unit changes a size of an image of the second area based on the boundary image data, the control unit sets the output address of the image expansion unit as an address immediately following the boundary image data.

6. The image processing apparatus according to claim 5, wherein when the image resizing unit changes the size of the image of the second area based on the boundary image data, the control unit sets an input address of the image resizing unit as an initial address of image data of the second area.

7. The image processing apparatus according to claim 4, wherein the expanded image data memory is a ring buffer.

8. An image processing method, comprising:
determining a size of an area configuring one portion of an image so that the size of the area is less than or equal to a capacity of an expanded image data memory which stores image data obtained by expanding compressed image data of a prescribed area, and is less than or equal to a capacity of a boundary image data memory which stores boundary image data of an area adjacent to an area corresponded to the image data stored in the expanded image data memory;
expanding compressed image data of the determined area;
changing a size of an image of an area corresponded to the expanded image data; and
storing boundary image data adjacent to another area of the expanded image data in the boundary image data memory.

9. An image processing method, comprising:
determining a size of an area configuring one portion of an image, and having a width identical to a width of the image, so that the size of the area is less than or equal to a capacity of an expanded image data memory which stores image data obtained by expanding compressed image data of a prescribed area;
expanding compressed image data corresponded to the determined area;
changing a size of an image of the area corresponded to the expanded image data; and
determining a next area to be expanded, and an output address to the expanded image data memory of image data obtained by expanding compressed image data of the next area based on the capacity of the expanded image data memory.
